(19) United States
(12) Patent Application Publication
(10) Pub. No.: US 2016/0341833 A1
(43) Pub. Date: Nov. 24, 2016

(54) RADIATION DETECTION APPARATUS

(71) Applicant: CANON KABUSHIKI KAISHA, Tokyo (JP)

(72) Inventors: Ikuo Watanabe, Yokohama-shi (JP); Yoshikatsu Ichimura, Tokyo (JP); Kazuyoshi Ishii, Tokyo (JP); Mitsuaki Amemiya, Saitama-shi (JP)

(21) Appl. No.: 15/157,151

(22) Filed: May 17, 2016

(30) Foreign Application Priority Data
May 20, 2015 (JP) 2015-102821

(51) Int. Cl. G01T 7/00; G01T 1/16

(52) U.S. Cl. CPC G01T 7/005; G01T 1/16

(57) ABSTRACT

An ionizing radiation detection apparatus of the present disclosure includes a first chamber holding a scattering gas thereinside; a first drift plane disposed inside the first chamber; a first electron detection unit disposed inside the first chamber so as to oppose the first drift plane; a second chamber connected to the first chamber, the second chamber holding the scattering gas thereinside; a second drift plane disposed inside the second chamber; a second electron detection unit disposed inside the second chamber so as to oppose the second drift plane; a calibration radiation source; and a control unit configured to compensate for a change in a multiplication factor of a signal output from each of the first electron detection unit and the second electron detection unit.

### BACKGROUND

1. Field of the Disclosure

The present disclosure relates to ionizing radiation detection apparatuses of an electron tracking type.

2. Description of the Related Art

An advanced Compton method is known as a conventional method for detecting a γ-ray. In the stated method, the incident direction of an incident γ-ray is calculated with the use of the energy and the scattered direction vector of a scattered γ-ray produced through Compton scattering as well as the energy and the recoil direction vector of a recoil electron produced through the Compton scattering.

Nuclear Science Symposium Conference Record (NSS/NIC 2010) discloses a time projection chamber (TPC), which is a γ-ray detection apparatus that utilizes an advanced Compton method. The TPC is filled with a gas serving as a scatterer, and a planar electron collector (μ-PIC) that multiplies an ionization electron and detects multiplied ionization electrons is disposed inside the TPC. A recoil electron produced through Compton scattering travels while successively ionizing gas molecules and produces an electron cloud formed of a number of ionization electrons in its trajectory. This electron cloud is subjected to the force of an electric field in an electron drift region and drifts to the electron collector while retaining substantially the same shape as the trajectory of the recoil electron. The electron collector carries out gas electron multiplication through an electron avalanche effect and detects the projection position of the electron cloud. (trajectory) on a two-dimensional plane.

Japanese Patent Laid-Open. No. 2010-078319 discloses a radiation gas monitor that corrects a gain variation arising in part from deterioration over time of a scintillator in a radiation detector.

A secondary electron ionized by a recoil electron is multiplied by a gas electron multiplier, but the gas electron multiplication factor varies as an outgassed substance from an inner surface or an internal structure of the gas chamber is mixed thereinto or as a quencher gas decomposes and deteriorates. Accordingly, the accuracy in determining the position (direction) of an incident γ-ray calculated on the basis of the detected energy of the recoil electron is reduced.

The energy of a calibration radiation source used in Japanese Patent Laid-Open No. 2010-078319 is higher than the energy of the source for measurement radiation. When the calibration radiation source emits a β-ray, a low--energy secondary electron can be mixed into a measurement energy region and detected as noise; and when the calibration radiation source emits a γ-ray, a low-energy scattered γ-ray produced through Compton scattering or a low-energy secondary electron can be mixed into the measurement energy region and detected as noise.

### SUMMARY

The present disclosure provides a radiation detection apparatus that includes a first chamber holding a scattering gas thereinside; a first drift plane disposed inside the first chamber; a first electron detection unit disposed inside the first chamber so as to oppose the first drift plane; a second chamber connected to the first chamber, the second chamber holding a scattering gas thereinside continuous with the scattering gas held inside the first chamber; a second drift plane disposed inside the second chamber; a second electron detection unit disposed inside the second chamber so as to oppose the second drift plane; a calibration radiation source; and a control unit configured to compensate for a change in a multiplication factor of a signal output from each of the first electron detection unit and the second electron detection unit.

The present disclosure has the following two features.

1. A calibration chamber in which a calibration detector is disposed is provided separately from a measurement chamber in which a measurement γ-ray detector is disposed, and a common gas is used continuously in the calibration chamber and the measurement chamber. Furthermore, a calibration radiation source is provided.

2. A nuclide that emits low-energy radiation (e.g., Fe-55 that is a proton-rich nuclide and radiates an X-ray of 5.9 key through an electron capture reaction) is selected as a calibration radiation source.

According to the present disclosure, radiation from the calibration radiation source can be prevented from being mixed into a measurement γ-ray detector, and the calibration chamber can be reduced in size.

Further features of the present disclosure will become apparent from the following description of exemplary embodiments with reference to the attached drawings.

### BRIEF DESCRIPTION OF THE DRAWINGS

FIG. 1 illustrates a configuration of an ionizing radiation detection apparatus according to an exemplary embodiment of the present disclosure.

FIG. 2 is a flowchart for describing an operation of the ionizing radiation detection apparatus according to an exemplary embodiment of the present disclosure.

FIG. 3 illustrates a configuration, of an ionizing radiation detection apparatus according to an exemplary embodiment of the present disclosure.

FIG. 4 is a flowchart for describing an operation of the ionizing radiation detection apparatus according to an exemplary embodiment of the present disclosure.

FIG. 5 is a graph illustrating a relation between the energy of an X-ray emitted by Fe-55 and the count value, in accordance with one or more embodiments of the present disclosure.

FIG. 6 is a schematic diagram for describing a microstrip gas chamber, in accordance with one or more embodiments of the present disclosure.

### DESCRIPTION OF THE EMBODIMENTS

Hereinafter, exemplary embodiments of the present disclosure will be described with reference to the drawings.

### First Exemplary Embodiment

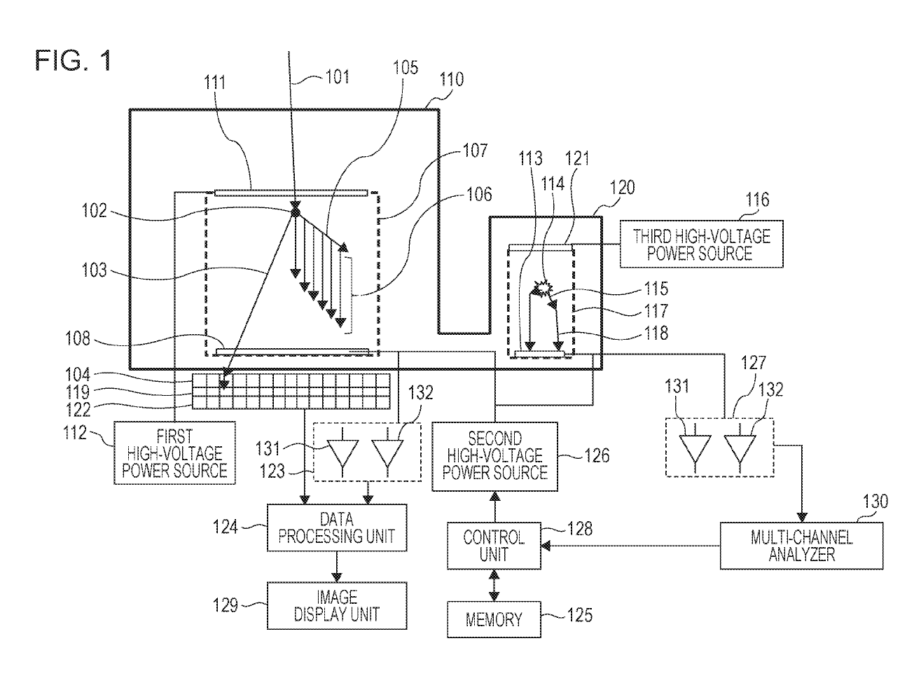

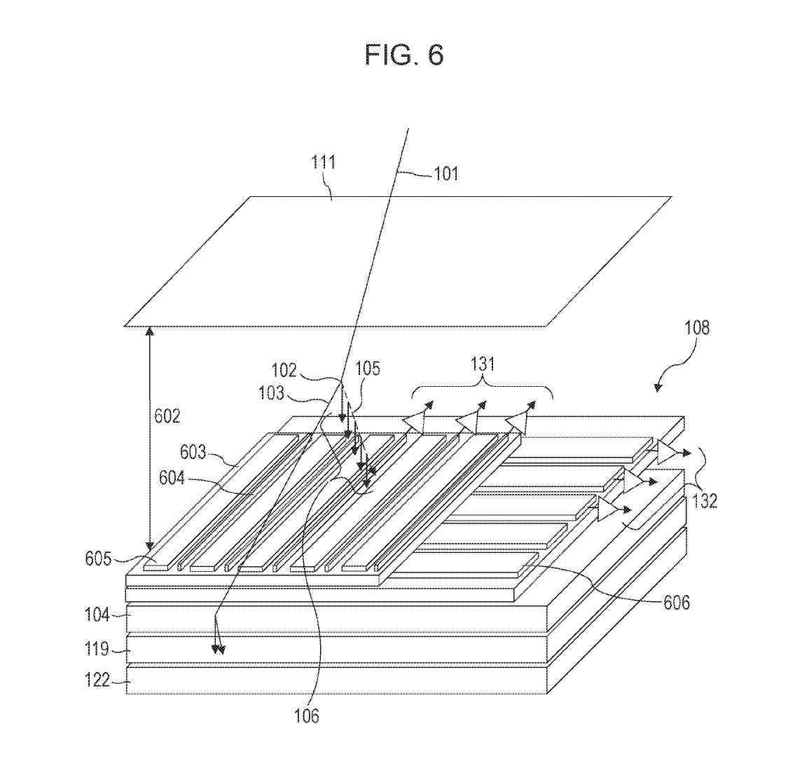

As illustrated in FIG. 1, a measurement chamber (first chamber) 110 holds thereinside a scattering gas 102 (e.g., a mixed gas containing 90% Ar+10% methane or ethane) for detecting ionizing radiation, and a. drift cage 107 is disposed inside the chamber 110. A measurement drift plane (first drift plane) 111, to which a negative high voltage from a first high-voltage power source 112 is applied, is disposed at an upper portion of the drift cage 107. A measurement secondary electron detection unit (first electron detection unit) 108, which is an electron sensor, is provided inside the measurement chamber 110 at a lower end thereof so as to oppose the measurement drift plane 111. A calibration chamber (second chamber) 120 is connected to the measurement chamber 110 via a tube, and the calibration chamber 120 holds thereinside a scattering gas 102 so as to be continuous with the scattering gas 102 inside the measurement chamber 110. Similarly to the interior of the measurement chamber 110, a calibration drift cage 117 is disposed inside the calibration chamber 120, and a calibration drift plane (second drift plane) 121 is disposed at an upper portion of the calibration drift cage 117. A small-sized calibration secondary electron detection unit (second electron detection unit) 113 is provided inside the calibration chamber 120 at a lower end thereof. The calibration secondary electron detection unit 113 may be constituted by a single element. When the calibration. secondary electron detection unit 113 is constituted by a plurality of elements, anode strips 604 may be connected in parallel to one another, and back strips 606 may also be connected in parallel to one another (see FIG. 6). In addition, a scintillator 104 of a two-dimensional array is disposed underneath the drift cage 107, and a multi-anode photomultiplier tube (MAPMT) 119 is disposed underneath the scintillator 104.

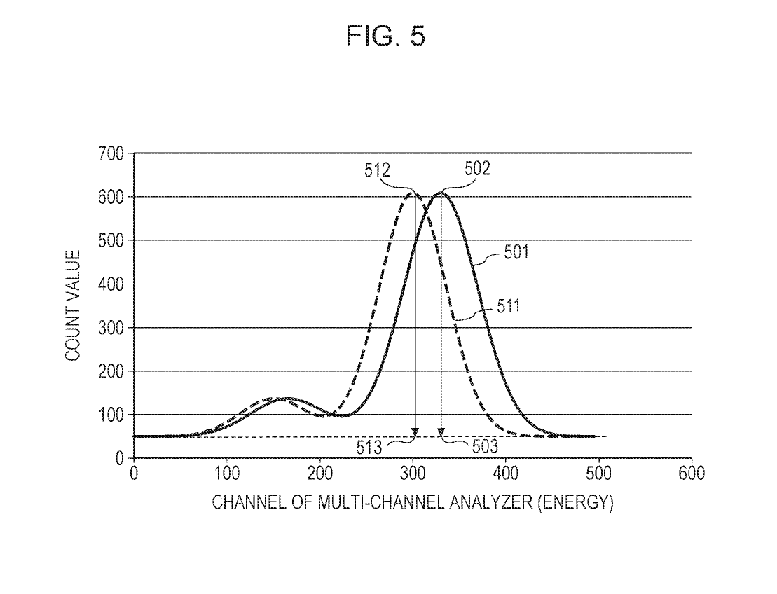

An output of a third high-voltage power source 116 is connected to the calibration drift plane 121, and an output of a second high-voltage power source 126 is connected to the calibration secondary electron detection unit 113. It is to be noted that a calibration radiation source 114 that emits relatively low-energy radiation is disposed inside the calibration chamber 120. A nuclide Fe-55 that changes into Mn-55 through an electron capture reaction and radiates an X-ray of 5.9 keV is suitable for the calibration radiation source 114. An X-ray 115 of 5.9 key illustrated in FIG. 1 has an absorption probability of 0.978 at a distance of 100 mm in Ar, and thus the X-ray 115 is annihilated by discharging a secondary electron 118 from Ar through a photoelectric effect. However, as illustrated in FIG. 5, part of the X-ray discharges a characteristic X-ray of 2.96 key from an Ar gas, and thus an escape peak at 5.9 key−2.96 key=2.94 key is also produced. When the calibration radiation source 114 is disposed outside the calibration chamber 120, a window member constituted by a thin plate made of resin or beryllium that transmits a low-energy X-ray may be provided in the calibration chamber 120, and the gas inside the calibration chamber 120 may be separated from the atmosphere.

An operation of the ionizing radiation detection apparatus will now be described. An incident γ-ray 101 passes through the measurement chamber 110 and the measurement drift plane 111 and causes Compton scattering to occur with an electron in the scattering gas 102. This Compton scattering produces a scattered γ-ray 103 and a recoil electron 105, and the recoil electron 105 produces a number of secondary electrons 106 along its trajectory. The scattered γ-ray 103 is converted to scintillation light by the scintillator 104. The scintillation light is photoelectrically converted and multiplied by the MAPMT 119 and is then converted to an electric signal by a head amplifier array 122 disposed underneath the MAPMT 119. The electric signal is sent to a data processing unit 124 as information on the sensed position of the scattered y-ray 103 and the energy of the scattered γ-ray 103.

In the meantime, the secondary electrons 106 move through an electric field generated by a negative voltage applied to the measurement drift plane 111 and are detected. by the measurement secondary electron detection unit 108. An output of the measurement secondary electron detection unit 108 is multiplied by a measurement multiplier 123, and the multiplied output is sent to the data processing unit 124 as secondary electron information. The data processing unit 124 obtains trajectory vector information, of the recoil electron 105 on the basis of the positional information and the energy information of the scattered γ-ray 103 and the secondary electron information. The data processing unit 124 carries out an inverse calculation of the Compton scattering on the basis of the stated pieces of information so as to calculate the direction in which the incident γ-ray 101 has entered, and the calculation result is displayed in an image display unit 129. An ionizing radiation detection apparatus that provides an image of an intensity distribution of a γ-ray emitted by a radiation source in this manner is typically referred to as a Compton camera.

Now, a method of detecting the secondary electrons 106 will be described in detail. FIG. 6 illustrates a configuration of a micros trip gas chamber (MSGC), serving as an example of the measurement secondary electron detection unit 108. Anode strips 604 and cathode strips 605 are disposed on an upper surface of the measurement secondary electron detection unit 108. The secondary electrons 106 move toward the anode strips 604 having a higher potential, but an electric field of 100,000 V/cm or higher is being generated between the anode strips 604 and the cathode strips 605. Therefore, more secondary electrons 106 are produced through an electron avalanche effect immediately before the secondary electrons 106 reach the anode strips 604, and gas electron multiplication with a factor of several ten thousand occurs. It is to be noted that the intervals between the anode strips 604 and the cathode strips 605 are approximately 50 μm, and thus an actual voltage is approximately 500 V. Signals of gas electrons are read out by anode multipliers 131, which makes it possible to determine which anode strips 604 the secondary electrons 106 have reached. Each anode multiplier 131 multiplies the signal by a factor of approximately one thousand and outputs the result to the outside. Back strips 606 are disposed underneath the anode strips 604 so as to extend perpendicularly to the anode strips 604 with a substrate 603, serving as an insulation layer, interposed therebetween. Back strip multipliers 132 multiply induced currents generated in the back strips 606 by the secondary electrons 106 that have reached the inside of the anode strips 604 and output the multiplied induced currents. This mechanism makes it possible to determine which portions of the anode strips 604 in the longitudinal direction the secondary electrons 106 have reached. It is to be noted that, although only five anode strips 604 are depicted schematically in FIG. 6, in reality, 200 or more anode strips 604 are disposed at an interval of approximately 200 μm. Each cathode strip 605 has a width of approximately 100 μm. The back strips 606 are disposed at an interval of approximately 200 μm.

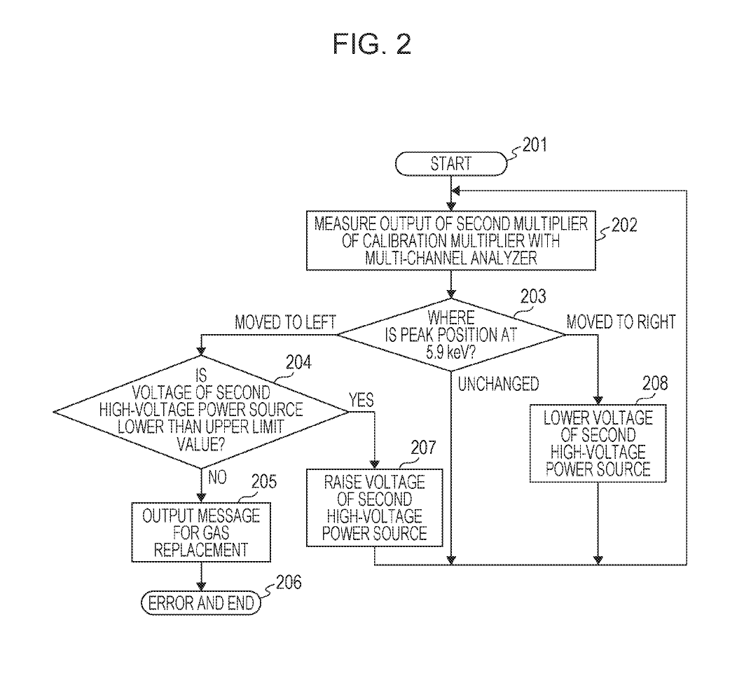

With reference to FIG. 2, a method of compensating for a change in the multiplication factor of the measurement secondary electron detection unit 108 and the calibration secondary electron detection unit 113 will now be described. The scattering gas 102 is ionized through a photoelectric effect caused by radiation emitted by the calibration radiation source 114 disposed inside the calibration chamber 120. An electron produced through the ionization is subjected to the gas electron multiplication by the calibration secondary electron detection unit 113, and the resulting signal is input to a multi-channel analyzer 130 via a calibration multiplier 127 as a radiation event. As illustrated in FIG. 2, following the start of the operation (step 201), an output of the calibration multiplier 127 is measured with the multi-channel analyzer 130 (step 202), and a peak position at 5.9 keV of an X-ray emitted by Fe-55 is measured from the waveform. An output of the multi-channel analyzer 130 held when shipped after being manufactured or after the scattering gas 102 has been replaced is indicated by a solid line 501 in FIG. 5, and a value 503 of the energy at the peak 502 of the count value at this time is written into a memory 125 (in FIG. 5, the horizontal axis represents the energy, and the vertical axis represents the count value of the incident radiation). When the scattering gas 102 deteriorates, the gain in the gas electron multiplication in the measurement MSGC and the calibration secondary electron detection unit 113 decreases, and the overall energy changes and shifts to the left even when the count value remains the same, as indicated by a dashed line 511 in FIG. 5. This can be clearly seen from the graph in which the peak 512 of the count value indicated by the dashed line 511 has moved to the left. A control unit 128 determines the peak position at 5.9 key (step 203). The control unit 128 determines whether the set voltage of the second high-voltage power source 126 is lower than a prescribed upper limit value (step 204). If the set voltage is lower than the upper limit value, the second high-voltage power source 126 is stepped up so that an energy value 513 at the peak value of the output of the multi-channel analyzer 130 connected to the output of the calibration secondary electron detection unit 113 takes the value written in the memory 125 (step 207). In other words, by controlling the gas electron multiplication factor, a change in the multiplication factor of the measurement secondary electron detection unit 108 and the calibration secondary electron detection unit. 113 is compensated for. When the set voltage of the second high-voltage power source 126 is no lower than the prescribed upper limit value, it is determined that the gas has deteriorated and it is time to replace the gas. Thus, a message urging a gas replacement is output (step 205), and the processing is terminated for an error (step 206).

The external dimensions of the calibration secondary electron detection unit 113 are smaller than the external dimensions of the measurement secondary electron detection unit 108, but the anode electrodes and the cathode electrodes used therein have the same size and are disposed at the same intervals. Accordingly, by applying, to the measurement secondary electron detection unit 108, a voltage that is equal to the voltage of the calibration secondary electron detection unit 113 on which radiation is constantly incident through the above-described procedure, the gain of the measurement secondary electron detection unit 108 can be corrected in a similar manner.

The gas can deteriorate through a deterioration mode in which an electronegative gas (e.g., H₂O and O₂) that tends to adsorb an electron and form a negative ion is mixed into the gas and the secondary electron 106 is adsorbed onto the drift. When the configuration is such that an influence of this adsorption deterioration mode in the calibration chamber 120 occurs in a similar manner to an influence in the measurement chamber 110, the multiplication factor can be compensated for with higher accuracy. In order to achieve this, the height at which the calibration radiation source 114 is installed may be determined as follows.

When the height of the measurement drift plane 111 is represented by L (602), a mean height, from the measurement secondary electron detection unit 108, of the position at which Compton scattering occurs to produce a secondary electron to be measured by the measurement secondary electron detection unit 108 is approximately 0.5 L. In addition, the recoil electron 105 generated through. Compton scattering tends to travel in a direction approaching the measurement secondary electron detection unit 108, and the mean height of the positions where the secondary electrons 106 are generated is, for example, in a range of 0.3 L to 0.5 L from the measurement secondary electron detection unit 108. Accordingly, the calibration radiation source 114 may be installed at a height of 0.3 L to 0.5 L (30% to 50%) from the calibration secondary electron detection unit 113. Then, the mean drift distance of the secondary electrons in the measurement chamber 110 substantially matches the mean drift distance of the secondary electrons in the calibration chamber 120. Consequently, the rate of a decrease in the gas electron multiplication gain of the energy of the recoil electron 105 through the above-described deterioration mode also becomes substantially equal in the measurement chamber 110 and in the calibration chamber 120.

### Second Exemplary Embodiment

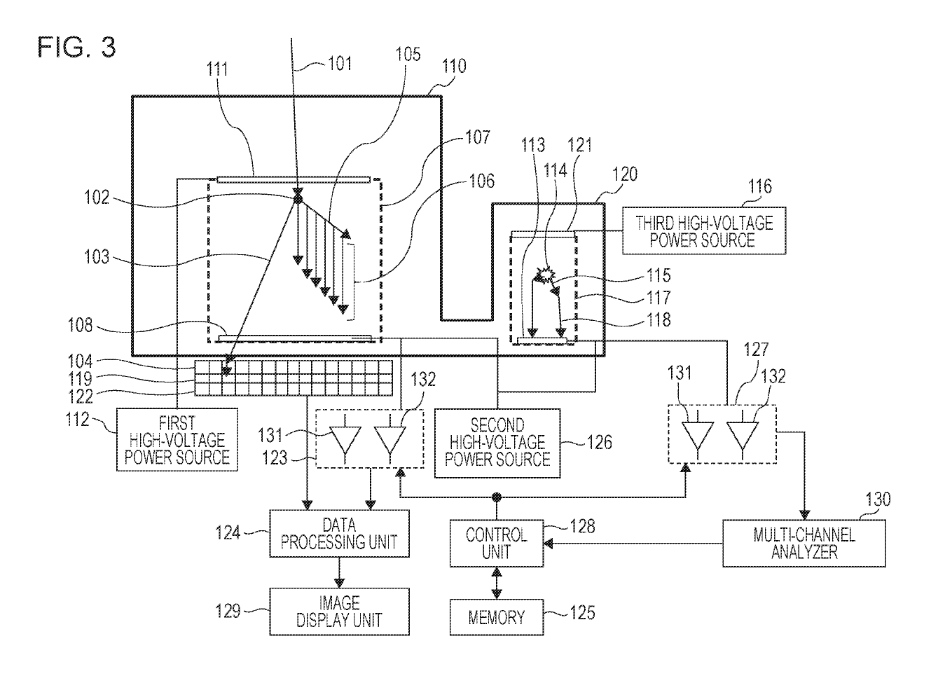

As illustrated in FIG. 3, in the present exemplary embodiment, the measurement multiplier (first multiplication unit) 123 and the calibration multiplier (second multiplication unit) 127 are controlled through an output of the control unit 128 instead of by controlling the voltage of the second high-voltage power source 126. Circuit of the same characteristics are used for the measurement multiplier 123 and the calibration multiplier 127, and the same gain control values are set therein. As a gain control value that is identical to the gain control value of the calibration multiplier 127 is applied to the measurement multiplier 123, the gain of the measurement multiplier 123 is corrected in a similar manner. In other words, by controlling the multiplication factor of the measurement multiplier 123 and the calibration multiplier 127, a change in the multiplication factor of the measurement secondary electron detection unit 108 and the calibration secondary electron detection unit 113 is compensated for.

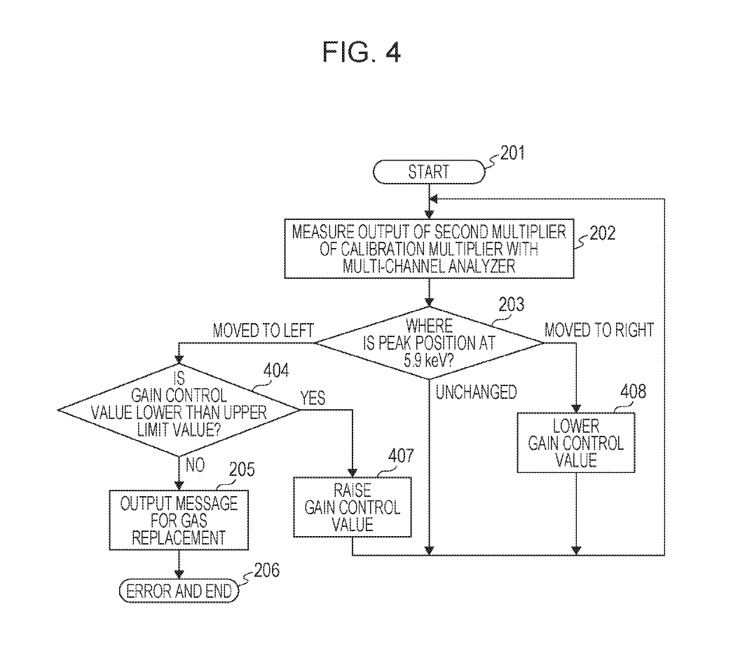

FIG. 4 is a flowchart illustrating a method of calibrating the gain of the gas electron multiplication according to the present exemplary embodiment. This method is the same as the method according to the first exemplary embodiment illustrated in FIG. 2 except in that the voltage control of the second high-voltage power source is replaced with the control of the gain control value.

### Third Exemplary Embodiment

In the ionizing radiation detection apparatus according to the first or second exemplary embodiment, on the basis of an output of the measurement secondary electron detection unit 108 and an output of a γ-ray detection unit constituted by the scintillator 104 and the MAPMT 119, an intensity distribution of a γ-ray is turned into an image, and the image is displayed in the image display unit 129.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-102821 filed May 20, 2015, which is hereby incorporated by reference herein in its entirety.

What is claimed is:

1. A radiation detection apparatus, comprising:
a first chamber holding a scattering gas thereinside;
a first drift plane disposed inside the first chamber;
a first electron detection unit disposed inside the first chamber so as to oppose the first drift plane;
a second chamber connected to the first chamber, the second chamber holding a scattering gas thereinside continuous with the scattering gas held inside the first chamber;
a calibration radiation source;
a second drift plane disposed inside the second chamber;
a second electron detection unit disposed inside the second chamber so as to oppose the second drift plane; and
a control unit configured to compensate for a change in a multiplication factor of a signal output from each of the first electron detection unit and the second electron detection unit.

2. The radiation detection apparatus according to claim 1, wherein the control unit controls a gas electron multiplication factor of each of the first electron detection unit and the second electron detection unit.

3. The radiation detection apparatus according to Claim. 1, wherein the control unit controls a multiplication factor of each of a first multiplication unit and a second multiplication unit that multiply signals output from the first electron detection unit and the second electron detection unit, respectively.

4. The radiation detection apparatus according to claim 1, wherein the calibration radiation source is constituted by a nuclide Fe-55.

5. The radiation detection apparatus according to claim 1, wherein the calibration radiation source is disposed at a position at which a mean drift distance of an electron detected by the first electron detection unit is substantially equal to a mean drift distance of an electron detected by the second electron detection unit.

6. The radiation detection apparatus according to claim 5, wherein the calibration radiation source is disposed at a position at which the calibration radiation source is spaced apart from the second electron detection unit in a direction toward the second drift plane by a distance that is 30% to 50% of an interval between the first electron detection unit and the first drift plane.

7. The radiation detection apparatus according to claim 1, wherein the scattering gas inside the second chamber is ionized by radiation emitted by the calibration radiation source, and an electron produced through ionization is detected by the second electron detection unit.

8. The radiation detection apparatus according to claim 1, further comprising:
an image display unit; and
a γ-ray detection unit,
wherein an intensity distribution of the incident γ-ray is turned into an image on the basis of an output of the first electron detection unit and an output of the γ-ray detection unit, and the image is displayed in the image display unit.
